(19) United States
(12) Patent Application Publication
(10) Pub. No.: US 2012/0216441 A1
(43) Pub. Date: Aug. 30, 2012

(54) FISHING POLE HOLDER

(76) Inventor: Dan R. Broderick, West Bountiful, UT (US)

(21) Appl. No.: 13/403,120

(22) Filed: Feb. 23, 2012

Related U.S. Application Data
(60) Provisional application No. 61/446,338, filed on Feb. 24, 2011.

(51) Int. Cl. A01K 97/10

(52) U.S. Cl. 43/21.2

(57) ABSTRACT

A fishing pole holder suitable for use with a conventional pole and reel, but secured into ice is contemplated to provide deep securement of the holder into the ice, and self stabilizing by the holder against the ice. The holder may actually work in other materials, such as logs and earth, but may be sized and shaped to be particularly well adapted to securement into ice. The handle for turning the shaft may eventually come to rest on the ice to stabilize the holder and fishing pole handle disposed therein.

### RELATED CASES

The application claims the benefit of U.S. Provisional Patent Application Ser. No. 61/446,338 filed Feb. 24, 2011 and entitled FISHING POLE HOLDER, which is incorporated herein by reference.

### BACKGROUND

1. The Field of the Invention

This invention relates to fishing equipment, and more particularly to novel methods and apparatus for holding a fishing pole.

2. The Background Art

Fishing has been a favorite pastime and vocation both for centuries and millennia. In the process of fishing, the fishing pole has become ubiquitous. In some circumstances, it is required by law that a fisherman be in close proximity and firm control of fishing apparatus. In other circumstances, a fisherman is allowed to use a holder. Various holders have been developed over the years for river fishing, lake fishing, fishing from a boat, fishing from land, and fishing from ice.

In ice fishing, one common fishing rig is called a “tip up.” With a tip up, the three legs of the tip up form a relatively stable tripod sitting on the ice. One of the legs is longer, and serves as a short fishing pole of sorts. In response to the tug of a fish pulling on the hook and line connected to the tip up, the tip up tips over. Thus, a flag is raised by the tip up and a fisherman is notified thereby that a fish has take the bait.

Regardless of mode, a fishing pole holder suitable for ice fishing, where the pole is a conventional pole, is still needed. Some of the features that are important include light weight, simplicity of operation, penetration ability for ice, holding ability to anchor the holder to the ice, and stability once anchored to the ice.

What is needed is a simple, effective, compact mechanism for holding a fishing pole when ice fishing. Being completely stationary or nearly so, a fisherman has enough difficulty staying warm, without frightening fish by the movement above the ice. Accordingly, it would be an advance in the art to provide a fishing pole holder that can remain stationary while a fisherman moves about elsewhere. Nevertheless, it would be an advance in the art if such a system could be lightweight, simple to use, provide simple and quick penetration into the ice, but remain firmly held by the ice after penetration.

Likewise, it would be an advance if such a system could have some stabilization mechanism to maintain the orientation of the pole once the fishing pole holder has been anchored to the ice. Thus, it would be an advantage to have multiple points of contact in order to stabilize the holder. If such a device could fit in a backpack, tackle box, or pocket, rather than being a large cumbersome apparatus, it would be so much the better.

### SUMMARY OF THE INVENTION

In view of the foregoing, in accordance with the invention as embodied and broadly described herein, a method and apparatus are disclosed in one embodiment of the present invention as including a holder formed to have a handle, which may be formed as a tubular member. Perpendicular to the handle is secured, typically by welding or other suitable fastening means a shaft. The shaft is threaded with flutes or flights of threads that have a deep cut or bite, being set off from the inner diameter of the threads, the shaft, by sufficient distance to provide good “purchase” in the ice when the threads are threaded into the ice.

In order to start the threads, and in fact to point is provided, which may be protected by a protective cover, such as a stiff piece of plastic or rubber tubing that can be slipped over or even threaded onto the threads on the shaft.

In certain contemplated embodiments, the handle may actually serve as a tubular member having an aperture therethrough. The aperture may be provided with grommets, gaskets, or other trim at the ends thereof in order to not wear on the handle of the fishing pole inserted therein. In other embodiments, the trim may actually serve at one end as a cutter in order to cut into the ice.

The shaft may be secured by threading, welding, or other fastening mechanisms. For example, the shaft may be provided with a hoop that extends round the handle portion, so that the shaft need not penetrate into the handle. By the same token, the shaft may simply be welded to the handle and thus be securely integrated therewith without any penetration through the handle to interfere with the location where the handle of the fishing pole needs to rest.

In use, an apparatus and method in accordance with the invention may involve finding a suitable location, cutting a hole through the ice, and dropping a baited hook from the end of the fishing hole down through the hole in the ice. Accordingly, upon determining a suitable location for resting the pole, a user may take the handle of the holder apparatus and applying palm pressure from the hand of a user dig the point of the shaft into the ice. The point may be angled at an angle that sets the handle or tube at the angle it will maintain in order to hold the handle of the fishing pole.

By turning the handle, the threads on the shaft form an effective auger. However, with applied pressure to the handle with the heel of the hand, a user may effectively not auger into the ice, so as to dig ice out, but rather force the threads to enter into the ice. Often, the ice may be cracked about the threads as the threads penetrate into the ice. However, given the energy applied to threading the shaft into the ice, the ice may temporarily fracture, and even have some local melting. Nevertheless, a metal shaft and threads readily conduct heat, and the ice surrounding any hole or fractured ice formed by the threads will typically re-freeze about the threads, thus anchoring the shaft in the ice.

A user may continue to push and rotate the handle, thus driving the threads and shaft further into the ice. Ultimately, one end of the handle will strike the ice first. At that time, a user may then continue to rotate until the other end of the handle strikes the ice, this time being drawn closer. Accordingly, a user may turn the handle back and forth to cut with one end of the handle a groove in the ice. Upon driving the shaft sufficiently deeply into the ice, the handle will be engaged by friction and otherwise against the ice, thus maintaining that particular position.

Thereupon, a user may then drop the handle of the fishing pole into the aperture or tubular opening in the handle of the holder. At that point, the fishing pole may be left unattended in the holder.

Moreover, the unit may also be used for shore fishing. For example, the threaded shaft may be anchored in a log or even in the ground. The large threads are particularly effective in large, old logs, which tend to have less integrity, due to decomposition. The length of the shaft and the depth of the threads combine to provide a secure grip into the log. Likewise, the orientation of the shaft may be selected to insert an any convenient angle to orient the holder portion and the fishing pole as desired.

Similarly, the threads may be sunk into a log or the earth at an angle, just as in ice. In this configuration, the tubular handle may engage the log or earth, stabilizing the handle of the holder and thus the fishing pole placed therein.

Likewise, anchored into a side of a log opposite the body of water being fished, the holder may be threaded into the log until the shaft is completely sunk thereinto. One may select any suitable angle, turning the threads into the log to partially or completely bury the threads therein. With the variations in log density, more or less of the threads may be engaged. In softer conditions, one may completely sink the shaft, securing the tubular handle snugly against the log.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of one embodiment of a fishing pole holder apparatus in accordance with the invention;

FIG. 2 is a rear perspective view of the apparatus of FIG. 1;

FIG. 3 is a front elevation view of the apparatus of FIG. 1;

FIG. 4 is a rear elevation view thereof;

FIG. 5 is a left end elevation view thereof;

FIG. 6 is a right end elevation view thereof;

FIG. 7 is a top plan view thereof;

FIG. 8 is a bottom plan view thereof, showing the shaft and the threads formed therearound;

FIG. 9 is a frontal perspective view of an apparatus in accordance with the invention in use with a fishing pole placed therein after penetration by the apparatus into the ice; and

FIG. 10 is a rear perspective view of an apparatus in accordance with the invention, anchored into the ice, and securing the handle of a fishing pole therein.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

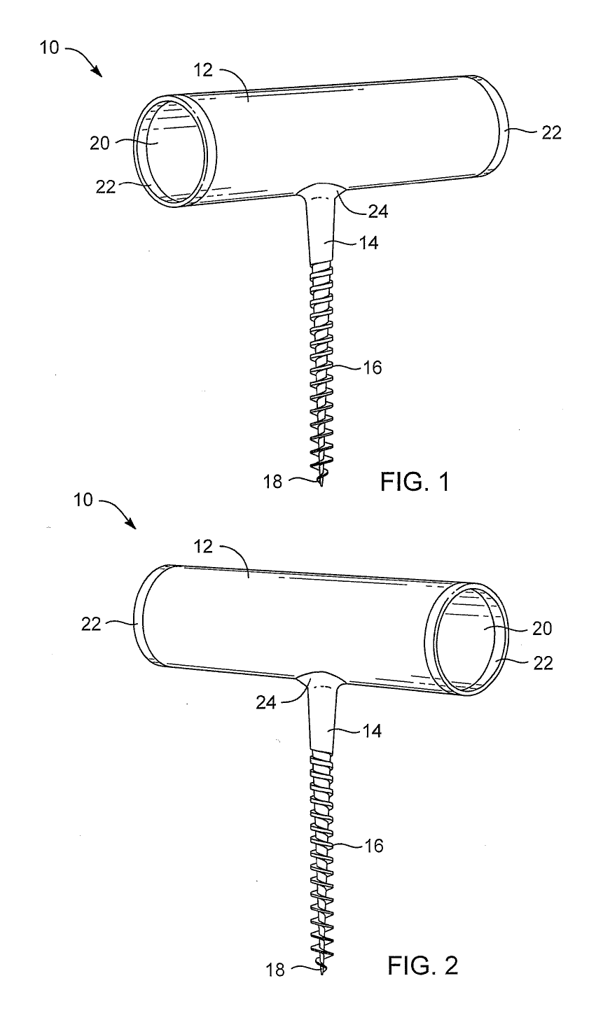

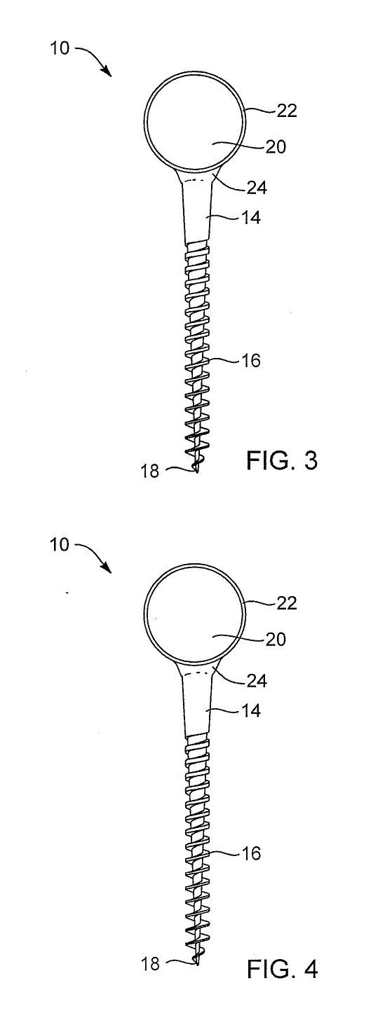

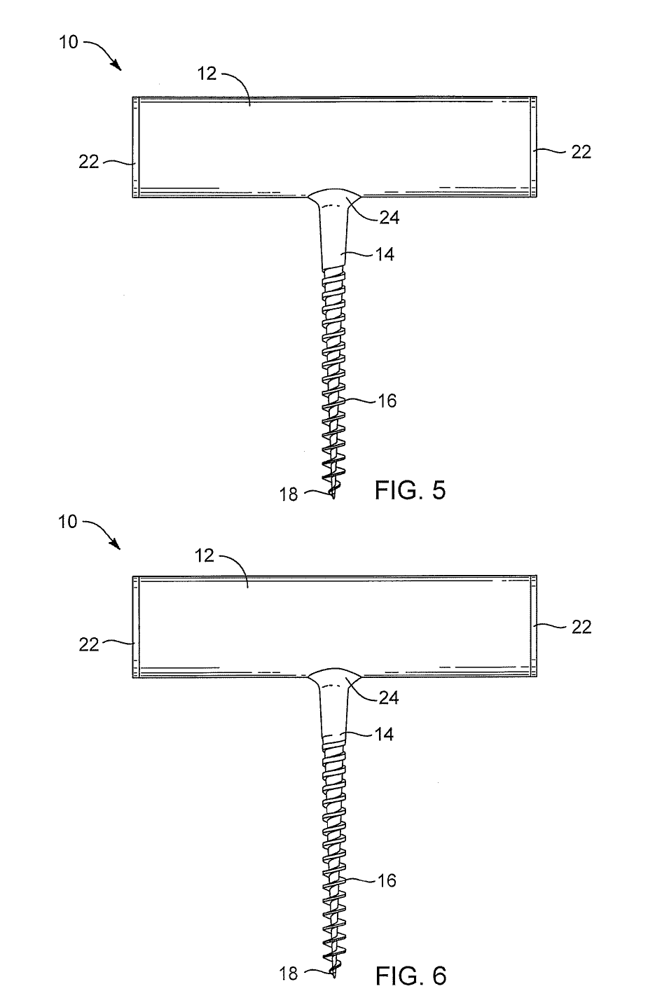

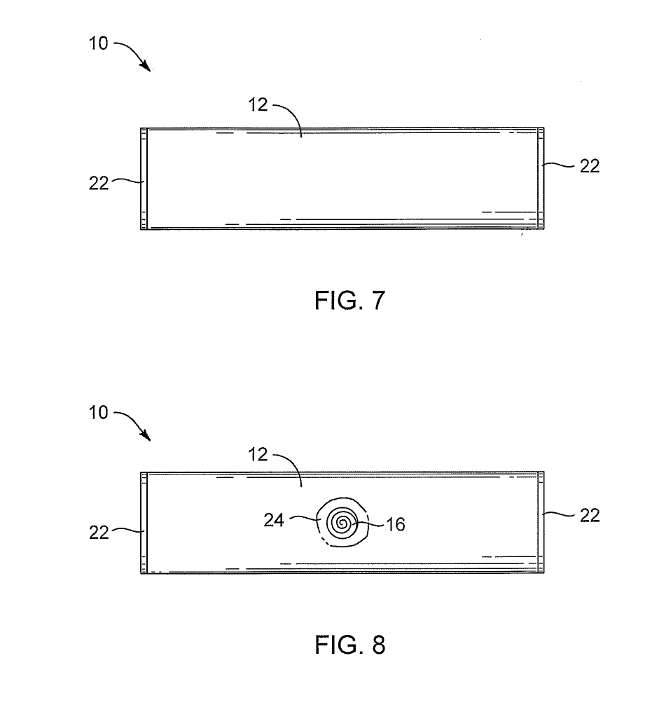

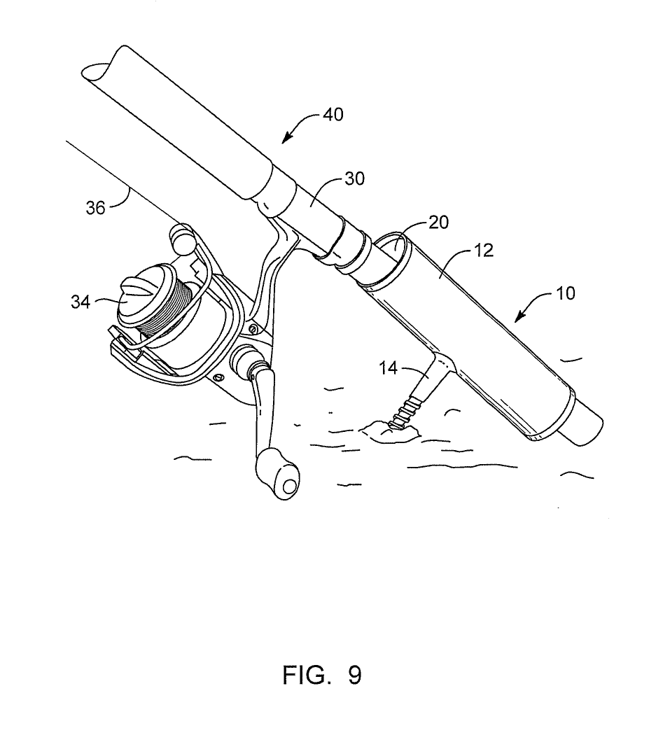

Referring to FIGS. 1-10, while referring specifically to FIG. 1, a fishing pole holder 10 or apparatus 10 in accordance with the invention may be formed to have a handle 12, typically a tubular member having an open tubular form and secured to a shaft 14 at approximately the center thereof. The apparatus 10 functions best if the shaft 14 is spaced to extend perpendicularly from a midpoint on the outside of the handle 12. The shaft may be provided with threads. It has been found that the threads 16 serve best if they are very deep. Accordingly, the shaft 14 obtains greater purchase on the ice, and the fracture of ice has been found to be less problematic since it can re-freeze within the large threaded openings, thus securing the shaft 14 in the ice.

In one embodiment in accordance with the invention, the shaft 14 may terminate in a sharp point 18. The point may include threads, or not. That is, for example, the threads 16 may advance along a majority of the shaft 14, and come completely to the point 18. In other embodiments, the point 18 may not include threads, but nearly a pick 18 that may be used to pick into the ice before engaging the threads 16. Nevertheless, in the illustrated embodiments, the threads 16 advance all the way to the point 18.

In one currently contemplated embodiment, the apparatus 10 maybe formed entirely of metal. In such an embodiment, the handle 12 may be formed of metal tubing, having an aperture 20 passing from end to end therethrough. In particular, it is a benefit to have the shaft 14 made of a metal such as steel. In an alternative embodiment, the shaft 14 may be secured to a hoop, through which the handle 12 is fitted. Thus, the handle 12 need not always be formed of the same material of the shaft 14.

The aperture 20 may be sized to fit a handle of a fishing pole. In certain embodiments, the aperture 20 may be trimmed with some sort of trim 22, such as a rubber gasket, a roughened or knurled treatment, a polymeric material to cover any metal edges, or the like. The trim 22 may be for decoration, but may also serve to protect the handle of the fishing pole inserted therein against damage.

In one currently contemplated embodiment, the securement 24 of the shaft 14 to the handle 12 may be provided in any suitable mechanically stable means. For example, in one embodiment, the shaft 14 may be welded 24 to the handle 12. Thus, the holder 10 becomes a fully integrated, single piece, unit.

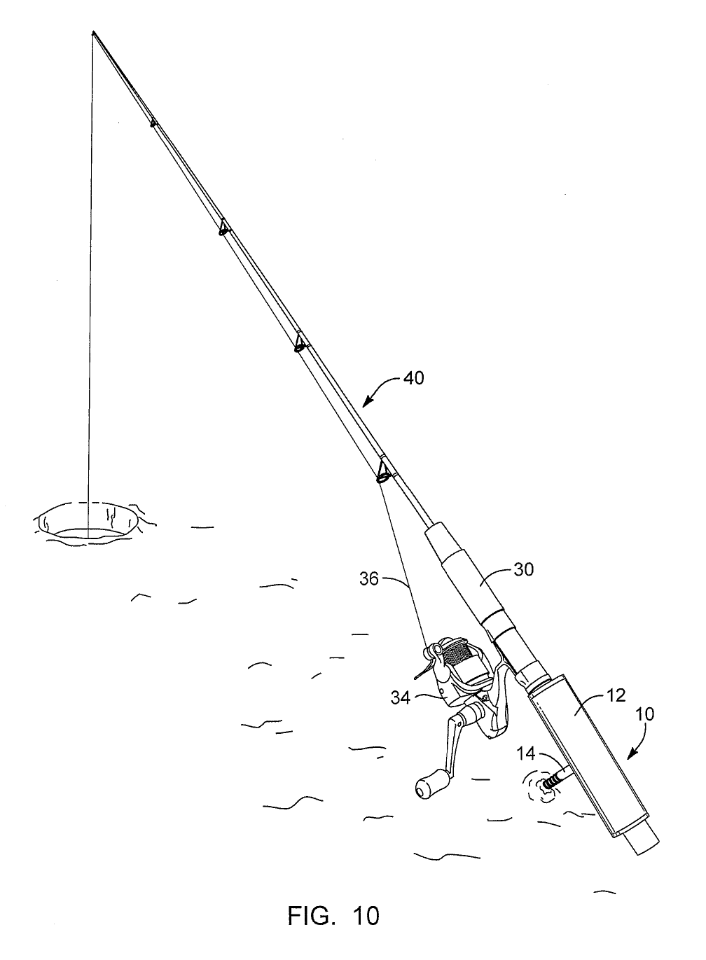

Referring to FIGS. 1-10, the fishing pole 30 of a user may include a handle 32. Accordingly, the holder 10 may be sized to fit a variety of handles 32. Presently, most fishing poles have a more-or-less standardized size for handles, in order to be able to support handles 32, in order to support attachment of a reel 34, and to provide space for the hands of a user to operate the reel 34 while holding the handle 32. Accordingly, the pole 30 may extend down into the aperture 20 of the handle 12 of the holder 10, once the apparatus 10 has been anchored into the ice. For example, referring to FIGS. 9-10, a user may select the approximate angle at which the holder 10 is to extend away from the ice. Accordingly, a user may then orient the handle portion 12 of the holder 10 at that angle, and drive the shaft 14 directly into the ice. Beginning with the point 18, a user may cut into the ice, engaging the threads 16 as the user rotates the shaft 14 under pressure by rotating and pushing on the handle 12 of the holder 10. After suitable application of force to the shaft 14 and the point 18, along with the rotating of the handle 12, the threads 16 will turn down into the ice. To a certain extent, the threads will cut into the ice as if cutting into wood or other solid materials. However, to a certain extent the threads 16 sometimes tend to break up the ice. Nevertheless, once rotation of the shaft 14 terminates, the ice trapped within the threads 16 quickly re-freezes by losing any additional energy back into the surrounding ice, thus anchoring the shaft 14 and the threads 16 securely in the ice.

As a user rotates the handle 12 and drives the shaft 14 further into the ice, the handle 12 eventually contacts the ice. As soon as the handle 12 begins to contact the ice, a user may begin to consider terminating the driving of the shaft 14 into the ice. The handle 12, the ends thereof will tend to cut into the ice and make a hollow therein. Thus, a user may cut the handle 12 into the ice in order to stabilize it, and resist any rotation of the shaft 14 forward or backward. Thus, one end of the handle 12 of the holder 10 digs into the ice, while the shaft 14 secures the handle 12 against the ice.

Once the holder 10 has been secured by means of the shaft 14 and its threads 16 into the ice, and has been stabilized in its position by engagement of one end of the handle 12 against the ice at a location away from the shaft 14, the holder 10 then has a certain amount of leverage in order to hold a fishing pole 30 in position. A user may then set the anterior end of the handle 32 into the aperture 20 of the handle 12. Typically, the length of the handle 12 of the holder 10 is of a length to provide a positioning of the reel 34 in a suitable location. Nevertheless, in one contemplated embodiment, the handle 32 of the fishing pole 30 may extend through the entire length of the handle 12, and may itself rest on the ice at the bottom end of the handle 12 of the holder 10. Meanwhile, the user may leave the line 36 extending from the reel through the ferules 38, eventually dropping off the end of the rod 40 into the water, where the bait and hook may do their service.

When a user sees the distal end of the rod 40 dipping, vibrating, bending, or the like, the user may grasp the handle 32 of the fishing pole 30, remove the handle 32 from the tube 12 or handle of the holder 10, and return to regular operation of the reel 34. After removing a fish, the user may then reset the bait, preparing the hook and bait and dropping the bait through the hole in the ice. Thereupon, the user may replace the handle 32 of the fishing pole 30 into the holder 10, and await another fish.

The unit 10 may also be used for shore fishing. For example, the threaded shaft 14 may be anchored in a log or even in the ground. The large threads 16 are particularly effective in large, old logs, which tend to have less integrity, due to decomposition. The length of the shaft 14 and the depth of the threads 16 combine to provide a secure grip into the log. Likewise, the orientation of the shaft 14 may be selected to insert an any convenient angle to orient the holder portion 12 and the fishing pole handle 32 as desired.

Similarly, the threads 16 and shaft 14 may be sunk into a log to position the handle 12 flush or tangent to the log. Also, the shaft 14 may be inserted into a log or the earth at an angle, just as in ice, coming to a stop once the handle portion 12 digs into the ground and stabilizes. In this configuration, the tubular handle 12 may rotate with the turning of the shaft 14 until it engages the log or earth, stabilizing the handle of the holder and thus the fishing pole handle 32 placed therein.

Likewise, anchored into a side of a log that is opposite the body of water being fished, the holder 10 may be threaded by the shaft 14 into the log until the shaft 14 is completely sunk thereinto. One may select any suitable angle, turning the threads 16 into the log to partially or completely bury the threads 16 therein. With the variations in log density, more or less of the threads may be engaged. In softer conditions, one may completely sink the shaft 14, securing the tubular handle 12 snugly against the log.

The present invention may be embodied in other specific forms without departing from its fundamental functions or essential characteristics. The described embodiments are to be considered in all respects only as illustrative, and not restrictive. All changes which come within the meaning and range of equivalency of the illustrative embodiments are to be embraced within their scope.

What is claimed and desired to be secured by United States Letters Patent is:

1. An apparatus for holding a fishing pole, the apparatus comprising:
a handle formed as a tubular member having an aperture extending thereinto;
a shaft secured to the handle, and extending perpendicularly thereto;
the shaft, having threads formed therein;
a securement fixing the shaft to the handle to support rotation of the shaft by rotating of the handle.

2. The apparatus of claim 1, wherein the securement and shaft are oriented to apply axial pressure to the shaft corresponding to a lateral force against the handle.

3. The apparatus of claim 1, wherein the securement is formed to extend the shaft perpendicularly with respect to a central axis of the handle.

4. The apparatus of claim 1, further comprising:
the handle, having a first end and a second end;
the handle, formed to have an aperture extending axially along the length thereof; and
the handle, wherein the first and second ends are formed to be operably interchangeable.

5. The apparatus of claim 1, wherein the shaft is mounted at a position substantially equidistant from a first end and a second end of the handle.

6. The apparatus of claim 1, wherein the threads are formed to extend the greatest distance from the shaft proximate the end of the shaft.

7. The apparatus of claim 1 about the shaft, and extending variable heights in a radially direction away from the shaft, the greatest height away from the shaft existing closest to the point of the shaft, and away from the handle, and away from the handle to be transferred into the shaft.

8. The apparatus of claim 1, wherein the shaft is further formed to a point at a distal end thereof.

9. The apparatus of claim 1, wherein the shaft forms an ice pick at a distal end thereof.

10. The apparatus of claim 1 further comprising a trim member applied to at least one end of the handle to protect a handle of a fishing pole inserted therein.

11. A method for holding a fishing pole, the method comprising:
providing an apparatus comprising
a handle formed as a tubular member having an aperture extending thereinto;
a shaft, having threads and secured to the handle to extend away therefrom;
a securement fixing the shaft to the handle.

12. The method of claim 11, wherein the shaft extends perpendicularly to the handle.

13. The method of claim 12, further comprising:
applying axial pressure to the shaft by applying a corresponding lateral force against the handle.

14. The method of claim 13, further comprising engaging, by the shaft, an anchor material at an anchor location by rotating the handle while applying axial force on the shaft.

15. The method of claim 14, further comprising:
inserting the shaft in the anchor location;
threading the shaft into the anchor material by rotating the handle; and
stopping the rotating by the handle engaging the anchor material.

16. The method of claim 15, further comprising:
orienting the handle at an angle selected for holding a fishing pole in an operable position.

17. The method of claim 16, wherein the handle has a first end and a second end, with an aperture extending axially therebetween, the first and second ends being formed to be operably interchangeable.

18. The method of claim 17, wherein the shaft is mounted equidistant from the first and second ends.

19. The method of claim 18, wherein the threads are deeper proximate a distal end of the shaft.

20. A method for fixing a fishing pole, the method comprising:
providing a holder having a handle with a central axis and a shaft fixed to the handle to extend away from central axis, the shaft being threaded;
grasping the handle;
engaging the threads in an anchoring material by applying a force laterally against the handle with respect to the central axis;
rotating the shaft by rotating the handle;
threading the shaft into the anchoring material until the handle stabilizes by engaging the anchoring material; and
positioning a fishing pole in an operable position inside the handle.
